(19) United States
(12) Patent Application Publication
(10) Pub. No.: US 2005/0100288 A1
(43) Pub. Date: May 12, 2005

(54) Light guide module having embedded LED

(75) Inventor: Chi-Chun Chu, Miaoli Hsien (TW)

Correspondence Address: BACON & THOMAS, PLLC, 625 SLATERS LANE, FOURTH FLOOR, ALEXANDRIA, VA, 22314, US

(73) Assignee: Sunplus Technology Co., Ltd., Hsinchu (TW)

(21) Appl. No.: 10/811,885

(22) Filed: Mar. 30, 2004

(30) Foreign Application Priority Data
Nov. 10, 2003 (TW) 092131407

(51) Int. Cl. G02B 6/26; G02B 6/42; G02B 6/36

(52) U.S. Cl. 385/88; 385/31; 385/33; 385/76

(57) ABSTRACT

A light guide module of optical mouse is disclosed. The light guide module comprises a LED die within a light guide input of light guide means. The light guide input comprises an internal paraboloid. Light emitted by the LED die and parallel reflected from the paraboloid is impinged on a light guide output.

### BACKGROUND OF THE INVENTION

1. Field of the Invention

The present invention relates to light guide module of optical mouse and, more particularly, to a light guide module of the optical mouse having an embedded LED (light emitting diode) with improved characteristics.

2. Description of Related Art

Interior details of a conventional optical mouse are shown in FIG. 1. The optical mouse comprises a LED 4 as light source, an optical module 5 for guiding rays of light to a surface of a table, and an image sensor 7 within the optical mouse for receiving rays of light reflected from the surface. It is seen that the LED 4 is located outside the optical module 5. Also, a clip 6 is provided to fix the LED 4 in a predetermined position so as to substantially bring together rays of light emitted from the LED 4 to the optical module 5.

However, the prior art suffered from several disadvantages. For example, it can significantly increase the manufacturing cost. Further, there are two transmissions (namely, a first one from a transparent protection member 41 of the LED 4 to air, and a second one from air to the optical module 5) before rays of light can reach the surface or an object. This process has a loss of light about 12% to about 15%. A solution to compensate the loss of light is by increasing illumination of LED. However, it may significantly consume power and shorten the useful life of LED. Hence, a need for the improvement of the light guide module of optical mouse exists.

### SUMMARY OF THE INVENTION

An object of the present invention is to provide a light guide module having an embedded LED so as to increase the efficiency of light guide, increase illumination, decrease power consumption, and prolong the useful life of LED.

Another object of the present invention is to provide a light guide module having an embedded LED having the advantages of simple light guide mechanism, removal of the conventional clip, easy assembly, and the reduced manufacturing cost.

To achieve the above and other objects, the present invention provides a light guide module of an optical mouse. The light guide module comprises a LED die; and light guide means including a light guide input, a light guide output, and an optical path between the light guide input and the light guide output, wherein the LED die is disposed in the light guide input of the light guide means, light emitted from the LED die is guided to the light guide output via the optical path, and the light guide input comprises an internal curve surface for impinging light emitted by the LED die and reflected from the curve surface on the light guide output via the optical path.

Other objects, advantages, and novel features of the invention will become more apparent from the detailed description when taken in conjunction with the accompanying drawings.

### BRIEF DESCRIPTION OF THE DRAWINGS

FIG. 1 is an exploded view of the interior of a conventional optical mouse;

FIG. 2 is a cross-sectional view of a preferred embodiment of the invention; and

FIG. 3 is a cross-sectional view of a portion shown in FIG. 2 for illustrating the reflection of light by a paraboloid.

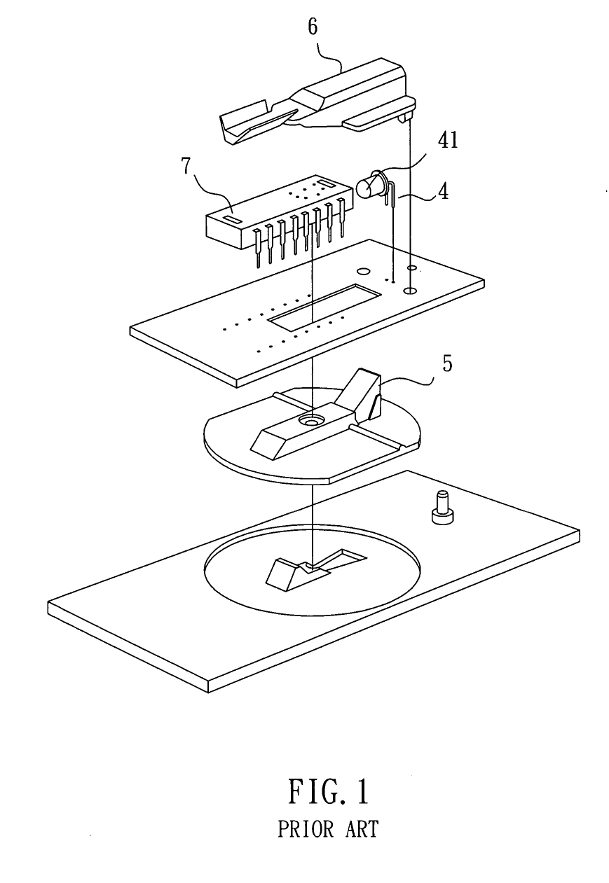

### DETAILED DESCRIPTION OF THE PREFERRED EMBODIMENT

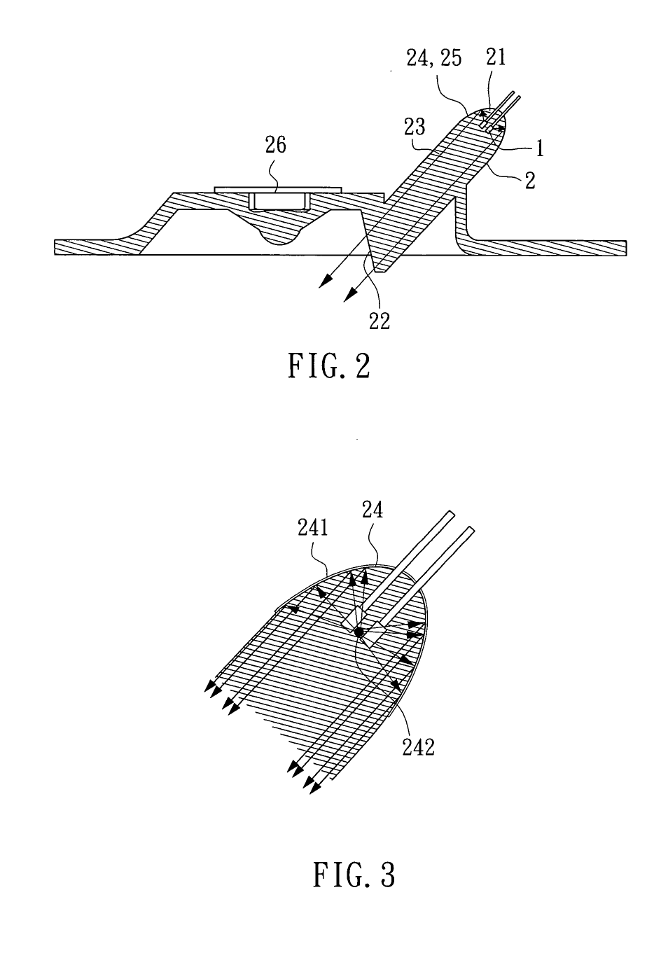

With reference to FIG. 2, there is shown a preferred embodiment of the invention. It comprises a LED die 1 and a light guide module 2. The light guide module 2 comprises a light guide input 21, a light guide output 22, and an optical path 23 between the light guide input 21 and the light guide output 22. Hence, input light from the light guide input 21 is adapted to output to the light guide output 22 via the optical path 23. As a result, light is able to impinge on the surface of an object.

The LED die 1 is disposed in the light guide input 21 of the light guide module 2. Light emitted from the LED die 1 is guided to the light guide output 22 via the optical path 23. The emitted light is transmitted to the light guide output 22 via a single medium (i.e., within the light guide module 2) since, as stated above, the LED die 1 is within the light guide module 2. This is contrary to the prior art which requires two transmissions via two different media before light can reach the light guide output. As a result, the invention can greatly reduce the loss of light due to light passing through different media.

With reference to FIG. 3 in conjunction with FIG. 2, the light guide input 21 of the light guide module 2 has an internal curve surface 25 for impinging light (emitted by the LED die 1 and reflected from the curve surface 25) on the light guide output 22 via the optical path 23. Preferably, the curve surface 25 is a paraboloid 24. The paraboloid 24 has a focus 242. The LED die 1 within the light guide input 21 of the light guide module 2 is located at the focus 242. Light (i.e., not parallel to the optical path 23) emitted from the LED die 1 at the focus 242 will impinge on the paraboloid 24. Next, light will reflect from the paraboloid 24 in a path parallel to the optical path 23. Hence, almost all rays of light emitted from the LED die 1 will be guided to the light guide output 22 prior to impinging on the surface of an object. Eventually, the impinged light will reflect from the surface of the object to an image sensor 26 for receiving and being processed. This has the advantage of decreasing the loss of light. More preferably, an opaque reflective film 241 is coated or formed on the curve surface 25 so as to substantially eliminate the loss of light due to transmission.

In brief, the LED die is arranged within the light guide module by the invention. Also, the internal surface of the light guide module is a paraboloid for reflecting light emitted from the LED die to the surface of an object via the optical path. The invention thus has the advantages of increasing the efficiency of light guide, increasing illumination, decreasing power consumption, prolonging the useful life of LED, simple light guide mechanism, removal of the conventional clip, easy assembly, and reducing the manufacturing cost.

Although the present invention has been explained in relation to its preferred embodiment, it is to be understood that many other possible modifications and variations can be made without departing from the spirit and scope of the invention as hereinafter claimed.

1. A light guide module of an optical mouse, comprising:
a LED die; and
light guide means including a light guide input, a light guide output, and an optical path between the light guide input and the light guide output,
wherein the LED die is disposed in the light guide input of the light guide means, and light emitted from the LED die is guided to the light guide output via the optical path.

2. The light guide module as claimed in claim 1, wherein the light guide input comprises an internal curve surface for impinging light emitted by the LED die and reflected from the curve surface on the light guide output via the optical path.

3. The light guide module as claimed in claim 2, wherein the curve surface is a paraboloid.

4. The light guide module as claimed in claim 3, wherein the LED die is located at a focus of the paraboloid.

5. The light guide module as claimed in claim 3, further comprising a reflective film coated or formed on the paraboloid.

6. The light guide module as claimed in claim 5, wherein the reflective film is opaque.
